(19) United States
(12) Patent Application Publication
(10) Pub. No.: US 2026/0006310 A1
(43) Pub. Date: Jan. 1, 2026

(54) IMAGE PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: AYANA KINOSHITA, Kanagawa (JP)

(21) Appl. No.: 19/246,409

(22) Filed: Jun. 23, 2025

(30) Foreign Application Priority Data
Jun. 26, 2024 (JP) 2024-103359

(51) Int. Cl. H04N 23/611; G06T 7/73; G06V 40/10

(52) U.S. Cl. CPC H04N 23/611; G06T 7/73; G06V 40/103

(57) ABSTRACT

According to an aspect of the present invention, an image processing apparatus includes one or more processors, and at least one memory coupled to the one or more processors and having stored thereon instructions, which when executed by the one or more processors, cause the image processing apparatus to function as a detection unit configured to detect a subject and a specific orientation of the subject from an image, an authentication unit configured to, based on information about a pre-registered specific subject, authenticate the specific subject, and a determination unit configured to, in a plurality of subjects detected from the image, determine a main subject based on a result of the specific orientation detection by the detection unit and a result of the authentication by the authentication unit.

### BACKGROUND

### Field of the Technology

The present invention relates to an image processing apparatus, and more particularly to main subject determination.

### Description of the Related Art

There is a technique for determining a main subject from among a plurality of subjects to maintain the main subject in focus during moving image capturing and in continuous photographing for successively capturing a plurality of images. Particularly in ball game scenes, a plurality of subjects can be complicated, and a subject not intended by a photographer may be determined as the main subject in some cases. Japanese Patent Application Laid-Open Publication No. 2021-71794 discloses a technique for acquiring subject orientation information and determining the main subject based on the reliability calculated based on the orientation information. Japanese Patent Application Laid-Open Publication No. 2008-187591 discloses an imaging apparatus that automatically selects a registered person, through face recognition, from among pre-registered tracking target persons.

The above-described conventional art does not consider main subject determination in a case where there is a subject having both orientation information and the registered person information.

The present invention is directed to providing a technique for determining the main subject close to the one intended by a photographer from among a plurality of subjects, based on orientation information and registered person information.

### SUMMARY

According to an aspect of the present invention, an image processing apparatus includes one or more processors, and at least one memory coupled to the one or more processors and having stored thereon instructions, which when executed by the one or more processors, cause the image processing apparatus to function as a detection unit configured to detect a subject and a specific orientation of the subject from an image, an authentication unit configured to, based on information about a pre-registered specific subject, authenticate the specific subject, and a determination unit configured to, in a plurality of subjects detected from the image, determine a main subject based on a result of the specific orientation detection by the detection unit and a result of the authentication by the authentication unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a configuration of an imaging apparatus.

FIG. 2 is a block diagram illustrating a detailed configuration of an image processing unit according to the first through sixth embodiments.

FIG. 3 is a flowchart illustrating main subject determination processing according to the first embodiment.

FIGS. 4A and 4B illustrate examples of main subject candidates when a main subject determination unit determines the main subject according to the first embodiment.

FIG. 5 is a flowchart illustrating main subject determination processing according to the second embodiment.

FIG. 6 is a flowchart illustrating main subject determination processing according to the third embodiment.

FIGS. 7A and 7B illustrate examples of main subject candidates when the main subject determination unit determines the main subject according to the third embodiment.

FIG. 8 is a flowchart illustrating main subject determination processing according to the fourth embodiment.

FIG. 9 illustrate examples of main subject candidates when the main subject determination unit determines the main subject according to the fourth embodiment.

FIG. 10 is a flowchart illustrating main subject determination processing according to the fifth embodiment.

FIGS. 11A and 11B illustrate examples of main subject candidates when the main subject determination unit determines the main subject according to the fifth embodiment.

FIG. 12 is a flowchart illustrating main subject determination processing according to the sixth embodiment.

### DESCRIPTION OF THE EMBODIMENTS

Embodiments of the present invention will be described in detail below with reference to the accompanying drawings.

The following embodiments do not limit the present invention within the scope of the appended claims. Although a plurality of features is described in the embodiments, not all of the plurality of features is indispensable to the present invention, and the plurality of features may be arbitrarily combined. In the accompanying drawings, identical or similar components are assigned the same reference numerals, and duplicated descriptions thereof will be omitted.

### Overall Configuration

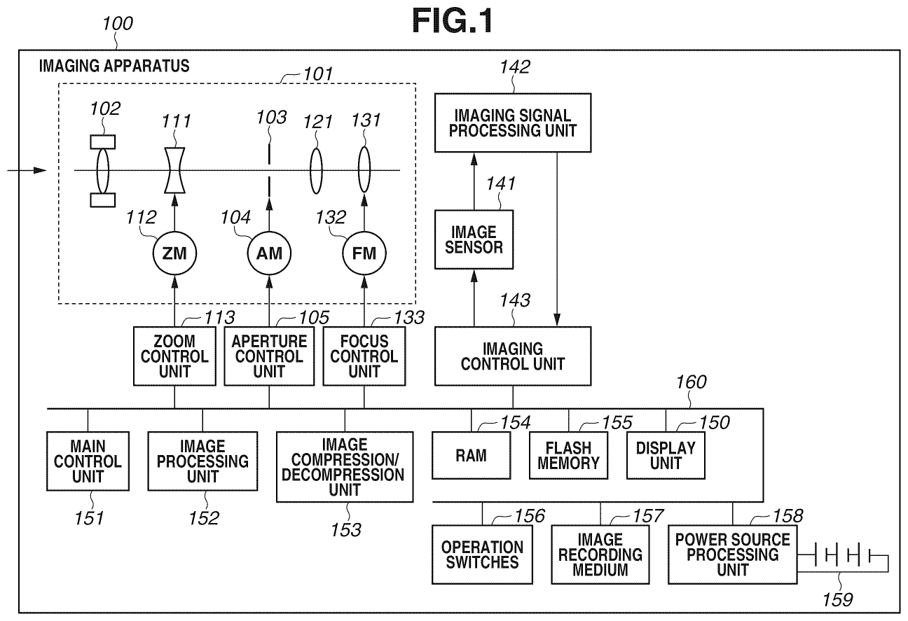

A first embodiment will be described below. FIG. 1 is a block diagram illustrating a configuration of an imaging apparatus 100 including a main subject determination apparatus. The imaging apparatus 100 is a digital still camera or a video camera that captures subject images and records moving and still image data in various media including a tape, solid-state memory, optical disk, and magnetic disk. However, the imaging apparatus 100 is not limited thereto. The following descriptions will be made on the premise that a person is a specific subject that can be determined as the main subject. More specifically, the imaging apparatus 100 performs processing for determining the main subject to be subjected to imaging control such as automatic focusing and automatic exposure control based on information and calculations (described below), from among a plurality of persons detected in input captured images. The present invention is applicable to various subjects including not only persons but also subjects having distinguishable features, such as animals and other animate beings, automobiles, and buildings. Also, the configuration illustrated in FIG. 1 is to be considered as an example configuration of the imaging apparatus 100.

Different units in the imaging apparatus 100 are connected with each other via a bus 160 and controlled by a main control unit 151.

A lens unit 101 includes a fixed first group lens 102, a zoom lens 111, an aperture 103, a fixed third group lens 121, and a focusing lens 131. An aperture control unit 105 drives the aperture 103 via an aperture motor (AM) 104 according to an instruction of the main control unit 151 to adjust the aperture diameter of the aperture 103 to adjust the light quantity at the time of imaging. A zoom control unit 113 drives the zoom lens 111 via a zoom motor (ZM) 112 to change the focal distance. A focus control unit 133 determines the drive amount for driving a focus motor (FM) 132 based on the deviation amount of the lens unit 101 in the focusing direction. In addition, the focus control unit 133 drives the focusing lens 131 via the focus motor (FM) 132 to control the focus adjustment state. The Automatic Focus (AF) control is implemented through the movement control of the focusing lens 131 by the focus control unit 133 and the focus motor 132. The focusing lens 131 is a focus adjustment lens, and is illustrated as a single lens in FIG. 1. However, the focusing lens 131 normally consists of a plurality of lenses.

A subject image formed on an image sensor 141 via the lens unit 101 is converted into an electrical signal by the image sensor 141. The image sensor 141 is a photoelectric conversion element for electrically converting a subject image (optical image) to an electrical signal, such as a Complementary Metal Oxide Semiconductor (CMOS) sensor. The image sensor 141 includes a light receiving element in which m pixels are arranged in the horizontal direction and n pixels are arranged in the vertical direction. The image captured and photoelectrically converted by the image sensor 141 is arranged as an image signal (image data) by an imaging signal processing unit 142. This enables acquiring the image on the imaging plane.

The image data output from the imaging signal processing unit 142 is transmitted to an imaging control unit 143 and then temporarily accumulated in a Random Access Memory (RAM) 154. The image data accumulated in the RAM 154 is compressed by an image compression/decompression unit 153 and then recorded in an image recording medium 157. In parallel with this processing, the image data accumulated in the RAM 154 is transmitted to an image processing unit 152.

The image processing unit 152 applies predetermined image processing to the image data accumulated in the RAM 154. The image processing applied by the image processing unit 152 includes what is called development processing (white balance adjustment processing, color interpolation (demosaic) processing, and gamma correction processing), signal format conversion processing, and scaling processing. However, the image processing is not limited thereto. The image processing unit 152 determines the main subject based on orientation information (e.g., joint positions) of the subject and positional information of a scene-specific object (hereinafter referred to as a specific object). The image processing unit 152 may apply information (processing result) of the main subject obtained in main subject determination processing to other image processing (e.g., white balance adjustment processing). The image processing unit 152 stores image data having undergone the predetermined image processing, the orientation information of each subject, information about the position and size of the specific object, and positional information of the center of gravity, face, and eyes of the main subject in the RAM 154.

An operation unit 156 is an input interface including a touch panel and buttons, and allows the user to perform various operations on the imaging apparatus 100 by selecting various function icons displayed on a display unit 150.

The main control unit 151 includes at least one programmable processor such as a central processing unit (CPU) and a micro processing unit (MPU). The main control unit 151 reads a program stored, for example, in a flash memory 155 into the RAM 154 and then executes the program to control each unit of the imaging apparatus 100 to implement the function of the imaging apparatus 100. The main control unit 151 also performs automatic exposure (AE) control processing for automatically determining exposure conditions (shutter speed or storage time, aperture value, and sensitivity) based on information about the subject luminance. The information about the subject luminance can be obtained, for example, from the image processing unit 152. The main control unit 151 can determine the exposure conditions based on a specific subject region such as the face of a person.

The focus control unit 133 performs AF control for the position of the main subject stored in the RAM 154. The aperture control unit 105 performs exposure control using the luminance value of a specific subject region.

The display unit 150 displays a result of image and main subject detection. A battery 159 is suitably managed by a power source management unit 158, and stably supplies power to the entire imaging apparatus 100.

The flash memory 155 stores control programs necessary for the operation of the imaging apparatus 100 and parameters to be used for the operation of each unit. When the imaging apparatus 100 is activated (when power is turned ON from the OFF state) by a user operation, the control programs and parameters stored in the flash memory 155 are read into a part of the RAM 154. The main control unit 151 controls the operation of the imaging apparatus 100 based on the control programs and constants loaded into the RAM 154.

### Main Subject Determination Processing

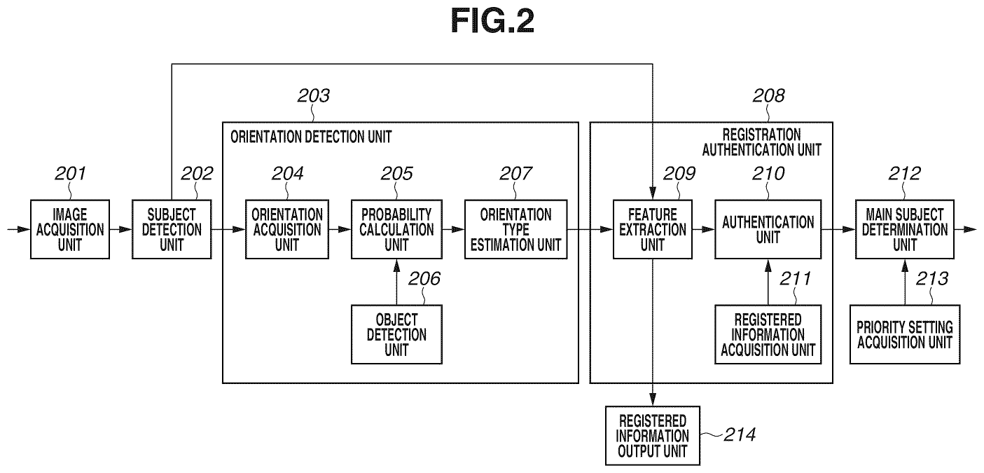

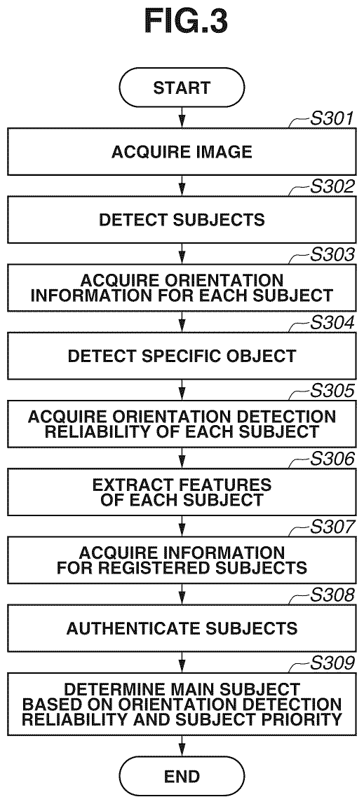

The main subject determination processing performed by the image processing unit 152 will be described below with reference to FIGS. 2 and 3. FIG. 2 is a block diagram illustrating a part of a detailed configuration of the image processing unit 152. FIG. 3 is a flowchart illustrating the main subject determination processing. Unless otherwise specifically described, processing of each step of this flowchart is implemented when different units of the image processing unit 152 operate under the control of the main control unit 151. In the following descriptions, the target imaging scene of the main subject determination processing is a ball game played by a plurality of players. However, imaging scenes to which the present embodiment is applicable are not limited thereto.

In step S301, an image acquisition unit 201 acquires an image captured at the target time from the imaging control unit 143. In step S302, a subject detection unit 202 detects a plurality of subjects in the image acquired by the image acquisition unit 201. An example case where the detected subjects are persons will be described below.

In steps S303 to S305, an orientation detection unit 203 detects the orientations of the subjects detected by the subject detection unit 202 and acquires orientation information for each subject.

In step S303, an orientation acquisition unit 204 acquires a plurality of joints and their positions as feature points (key points) for each subject by using a first learning model trained through machine learning.

In step S304, an object detection unit 206 detects a specific object (object of a predetermined type) in the image acquired by the image acquisition unit 201, and acquires the two-dimensional coordinates and the size of the specific object in the image. The type of the specific object to be detected is determined based on the imaging scene of the image. Since the imaging scene in this case is a ball game, the object detection unit 206 detects a ball as a specific object. However, the specific object is not limited thereto. Examples of specific objects include a goal, a racket (in a racket sport), and other objects as long as a specific orientation can be detected.

In step S305, the orientation of each subject is estimated based on information about the acquired joints and their positions by using a second learning model trained through machine learning. The method for estimating the orientation is not limited thereto. The orientation may be estimated solely by rule-based processing or in combination with machine learning. Further, the subject orientation may be estimated by using a plurality of frames or by using any other methods. A probability calculation unit 205 calculates the orientation detection reliability (probability and score) representing the likelihood of the specific orientation for each subject based on the joint coordinates estimated by the orientation acquisition unit 204, and at least one of the coordinates and size of the specific object acquired by the object detection unit 206. Values other than the probability are also usable as the orientation detection reliability. For example, the reciprocal of the distance between the center of gravity of the subject and the center of gravity of the specific object can be used as the orientation detection reliability. Although the present embodiment detects the likelihood of the specific orientation by also using specific object information, the likelihood of the specific orientation can also be detected by using only subject orientation information. In addition, for joint positions and the position and size of the specific object, data having been subjected to predetermined conversion such as linear conversion may be used as input data. The orientation detection reliability calculated in step S305 is stored in the RAM 154 for use in subsequent main subject determination processing.

In steps S306 to S308, the registration authentication unit 208 acquires information about pre-registered registered subjects and checks whether each or some of the subjects detected by the subject detection unit 202 matches the information about the registered subjects. For each successfully authenticated subject, the registration authentication unit 208 acquires the subject priority included in the information about registered subjects. Steps S303 to S305 and steps S306 to S308 do not necessarily need to be executed in this order. The processing in steps S303 to S305 may be executed after the processing in steps S306 to S308.

The information about registered subjects to be pre-registered and procedures for registration processing will be described below. Like the main subject determination processing, the registration processing is performed by the image processing unit 152. The subject detection unit 202 detects subjects from the captured image data for registration (hereinafter referred to as an image for registration) prepared by the user. Then, the user selects registration target persons from among the detected subjects. The feature extraction unit 209 extracts feature information for the detected subjects from the image portion of the selected subjects in the image for registration. Examples of algorithms used to extract feature information include an algorithm for acquiring feature information on a rule basis from the coordinates of feature points of facial parts such as the eyes, nose, and mouth, and an algorithm for acquiring feature information by inputting an input image to a neural network and outputting the feature information.

A registered information output unit 214 associates the extracted subject feature information, subject region images, subject priority, header information, and subject information with each other, and stores these pieces of information as one piece of registered information in the RAM 154. The subject priority includes the priority within a plurality of registered subjects, and may be specified by the user. The subject priority may be set on the camera side based on the registration order or the authentication frequency after registration.

Descriptions of FIG. 3 will be resumed. In step S306, the feature extraction unit 209 extracts the feature information for each detected subject from the image portion of the detected subject. The feature extraction unit 209 inputs the extracted feature information to an authentication unit 210.

In step S307, a registered information acquisition unit 211 acquires the feature information and the subject priority for the registered subjects from the RAM 154 and inputs these pieces of information to the authentication unit 210.

In step S308, the authentication unit 210 calculates the degree of similarity between the acquired feature information of the registered subject and the feature information of the detected subject input from the feature extraction unit 209, and generates an authentication reliability representing the degree of similarity. If the authentication reliability is equal to or higher than a predetermined threshold value, the authentication unit 210 determines successful authentication (the detected subject is a registered subject). If the authentication reliability is less than the predetermined threshold value, the authentication unit 210 determines failed authentication. Then, the authentication unit 210 stores the result of the determination together with the authentication reliability and the subject priority in the RAM 154.

In step S309, a main subject determination unit 212 performs the main subject determination processing based on the orientation detection reliability included in the orientation information acquired in step S305 and the subject priority acquired in step S308. The main subject determination unit 212 sums up the orientation detection reliability and the subject priority for each subject to calculate the score of the likelihood of the main subject (hereinafter referred to as the main subject score), and determines the subject having the highest main subject score as the main subject. In this case, the scores of the orientation detection reliability and the subject priority may be tuned (normalized) in advance to allow the scores to be evaluated through a simple addition. The weight corresponding to the one to be emphasized may be adjusted by user settings, and the score of the total likelihood of the main subject may be calculated through a weighted addition.

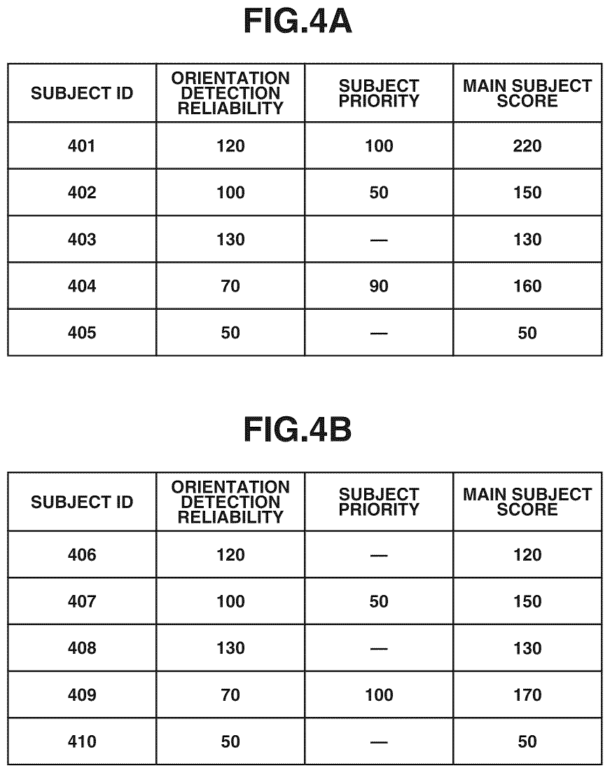

FIGS. 4A and 4B illustrate examples of the subject information when the main subject determination unit 212 determines the main subject. An identifier (ID) is assigned to each of the detected subjects, and each subject is attached with information about the orientation detection reliability and the subject priority. If there is a plurality of pieces of subject information as illustrated in FIG. 4A, the main subject determination unit 212 determines a subject 401 having the highest main subject score as the main subject.

The main subject is determined based on the total score as described above. Therefore, the main subject determination unit 212 may determine the subject having the highest main subject score as the main subject even if there exists a subject having an orientation detection reliability below a predetermined threshold value of reliability. If the threshold value of the orientation detection reliability is set to 90 in FIG. 4B, the subject 409 has an orientation detection reliability equal to or less than the threshold value. However, the subject 409 has the highest main subject score as the sum of the orientation detection reliability and the subject priority. In this case, the subject 409 having the highest likelihood of the main subject is determined to be the main subject even if the subject 409 has an orientation detection reliability equal to or less than the threshold value. A certain subject which should be determined as the main subject has been undetected due to a lower orientation detection reliability than a criterion. However, increasing the subject priority of such a subject as described above enables determining the subject as the main subject. For subjects with which the subject priority has not been registered, the main subject determination unit 212 uses the orientation detection reliability as the main subject score without using the subject priority, and determines the person having the highest main subject score as the main subject.

Then, the main subject determination unit 212 stores the joint coordinates of the main subject and the representative coordinates representing the main subject (center-of-gravity position or facial position) as the main subject information in the RAM 154. This completes the main subject determination processing.

As described above, according to the first embodiment, if a plurality of main subject candidates exists, the main subject score is calculated based on the orientation detection reliability and the subject priority, and the subject having the highest main subject score is determined as the main subject. This enables selecting the main subject in consideration of the orientation detection information and the registered subject information.

A second embodiment has a similar basic configuration of the imaging apparatus 100 to the first embodiment. Differences of the present embodiment from the first embodiment will be mainly described below.

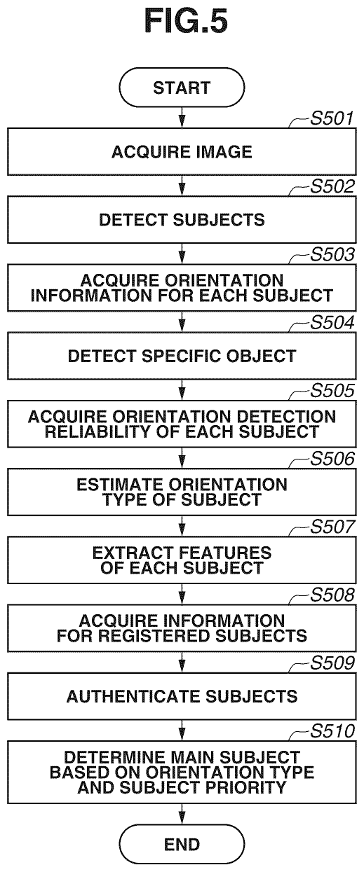

FIG. 5 is a flowchart illustrating the main subject determination processing according to the present embodiment. In step S505, the orientation detection reliability of the subject is acquired, and in step S506, an orientation type estimation unit 207 estimates the orientation type of the subject with the specific orientation detected. To estimate the orientation type, the object detection unit 206 uses the joint coordinates estimated by the orientation acquisition unit 204 and the specific-object coordinates acquired by the object detection unit 206. In an example case of volleyball, if the wrist joint of one hand is positioned above the head, and a ball as a specific object is positioned near the wrist, an orientation of hitting a spike can be estimated. In this case, a method for estimating the orientation type based on the joint coordinates and the specific-object coordinates is used. However, the orientation type may also be estimated by using other methods such as deep learning.

In step S510, the main subject determination unit 212 performs the main subject determination processing based on the orientation type estimated in step S506 and the subject priority acquired in step S308. Detected subjects are given priority in the order of a subject in a scoring-related orientation, a registered subject, and a subject not in a scoring-related orientation. For example, upon detection of a subject in a scoring-related orientation which should be given priority, the subject is determined to be the main subject even in a case where a registered subject or a subject not in a scoring-related orientation has a higher main subject score. If an item that should be given priority is detected or authenticated in this way, this method determines the subject as the main subject. Other applicable methods include a method for calculating the main subject score by giving a large weight to the subject corresponding to the item that should be given priority.

If a plurality of registered subjects exists, the method according to the present embodiment preferentially determines the main subject in order of the subject priority. If a subject taking a scoring-related orientation such as a shooting orientation exists within the angle of view, the method gives priority to the subject. If no scoring-related subject exists, the method gives priority to registered subjects. In this way, the method enables selecting the main subject according to situation. Examples of scoring-related orientations include a shot or header in soccer, a spike in volleyball, and a shot in basketball. However, scoring-related orientations are not limited thereto but can be defined for each game. On the contrary, examples of scoring-unrelated orientations include at least one of pass and dribble in soccer and basketball and at least one of toss and receive in volleyball.

If the main subject has already been determined to be a registered subject in the main subject determination before the target time, the main subject may not be changed depending on the orientation type of the detected subject. For example, even if only a subject not in a scoring-related orientation appears in a state where the main subject is a registered subject, the registered subject continues to be the main subject.

As described above, the second embodiment determines the main subject based on the orientation type and the subject priority when a plurality of main subject candidates exists. This enables selecting the main subject in consideration of the orientation detection information and the registered subject information.

A third embodiment has a similar basic configuration of the imaging apparatus 100 to the first and the second embodiments. Differences of the present embodiment from the first embodiment will be mainly described below.

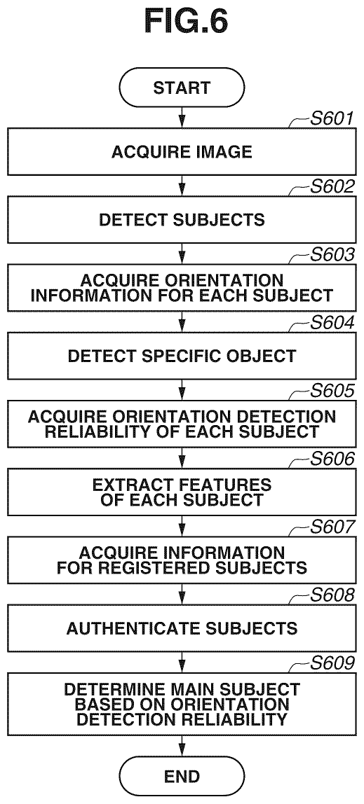

FIG. 6 is a flowchart illustrating the main subject determination processing according to the present embodiment. In step S609, the main subject determination unit 212 performs the main subject determination processing, giving priority to the orientation detection reliability included in the orientation information acquired in step S605. Among the detected subjects, the main subject determination unit 212 determines the subject having the highest orientation detection reliability as the main subject. More specifically, if there is a subject (first subject) with the specific orientation detected, the subject is given priority even if there exists a specific subject (other than the first subject) detected with any high authentication reliability.

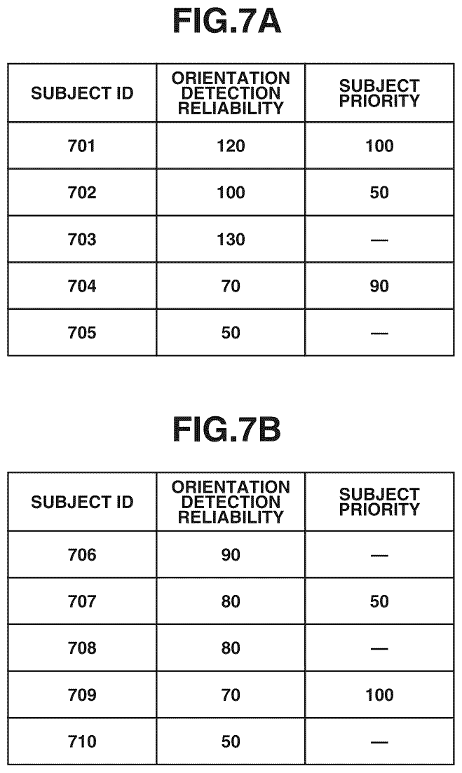

If there is no subject having an orientation detection reliability equal to or larger than the threshold value in detected subjects (if the specific orientation is detected from none of subjects), a subject is likely to be determined to be the main subject in the order of registered subjects having a high subject priority, and detected subjects without the orientation information and the authentication information. In the above-described control, even if the main subject has been determined to be a registered subject in the main subject determination before the target time, the main subject is changed to the subject having the highest orientation detection reliability. FIGS. 7A and 7B illustrate examples of subject information when the main subject determination unit 212 determines the main subject. If there is a plurality of pieces of subject information as illustrated in FIG. 7A, a subject 703 having the highest orientation detection reliability is determined as the main subject. If the threshold value of the orientation detection reliability is set to 100 in FIG. 7B, there is no subjects having an orientation detection reliability equal to or larger than the threshold value. Therefore, a subject 709 having the highest subject priority is determined as the main subject. If there is a person in a shooting orientation in a game of sports, for example, the above-described main subject determination processing enables preferentially determining the person as the main subject. If there is no person in a shooting orientation within the angle of view, a registered person can be preferentially determined as the main subject.

As described above, according to the third embodiment, if there is a plurality of main subject candidates, the main subject is determined based on the orientation type. Among the detected subjects, the subject having the highest orientation detection reliability is determined as the main subject. If there is no subject having an orientation detection reliability equal to or larger than the threshold value in the detected subjects, the main subject is selected in the order of registered subjects having a high subject priority, and detected subjects without the orientation information and the authentication information. This enables selecting the main subject in consideration of the information about registered subjects while giving priority to the subject with the specific orientation detected.

A fourth embodiment has a similar basic configuration of the imaging apparatus 100 to the first to the third embodiments. Differences of the present embodiment from the first embodiment will be mainly described below. According to the present embodiment, instead of the score calculation based on the subject priority registered for a case where a pre-registered specific subject is authenticated in the first to the third embodiments, the fourth embodiment calculates the reliability of the authentication result and reflects the reliability to the score.

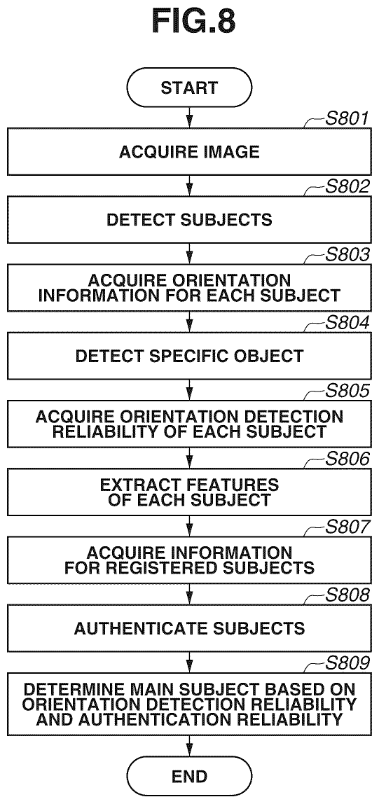

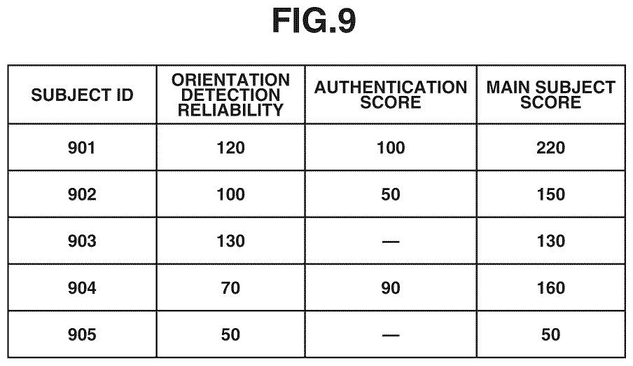

FIG. 8 is a flowchart illustrating the main subject determination processing according to the present embodiment. In step S809, the main subject determination unit 212 performs the main subject determination processing based on the orientation detection reliability included in the orientation information acquired in step S805 and the authentication reliability acquired in step S808. The main subject determination unit 212 sums up the orientation detection reliability and the authentication reliability to calculate the main subject score for each subject, and determines the subject having the highest main subject score as the main subject. FIG. 9 illustrates an example of subject information when the main subject determination unit 212 determines the main subject. If there is a plurality of pieces of subject information as illustrated in FIG. 9, the main subject determination unit 212 determines a subject 901 having the highest main subject score as the main subject. Although the present embodiment uses a simple addition to calculate the main subject score, other calculation methods such as multiplication and weighting to the score are also applicable.

As described above, if there is a plurality of main subject candidates, according to the fourth embodiment, the main subject score is calculated based on the orientation detection reliability and the authentication reliability, and the subject having the highest main subject score is determined as the main subject. This enables selecting the main subject in consideration of the orientation detection information and the registered subject information.

A fifth embodiment has a similar basic configuration of the imaging apparatus 100 to the first to the fourth embodiments. Differences of the present embodiment from the first embodiment will be mainly described below.

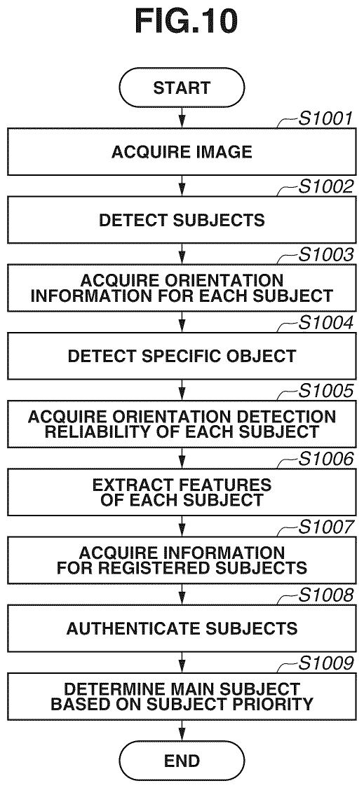

FIG. 10 is a flowchart illustrating the main subject determination processing according to the present embodiment. In step S1009, the main subject determination unit 212 determines the main subject, giving top priority to the authentication information acquired in step S1008. More specifically, if there is a subject (second subject) authenticated as the specific subject, the subject is given priority and determined as the main subject even if there exists a subject (other than the second subject) with the specific orientation detected with any high orientation detection reliability.

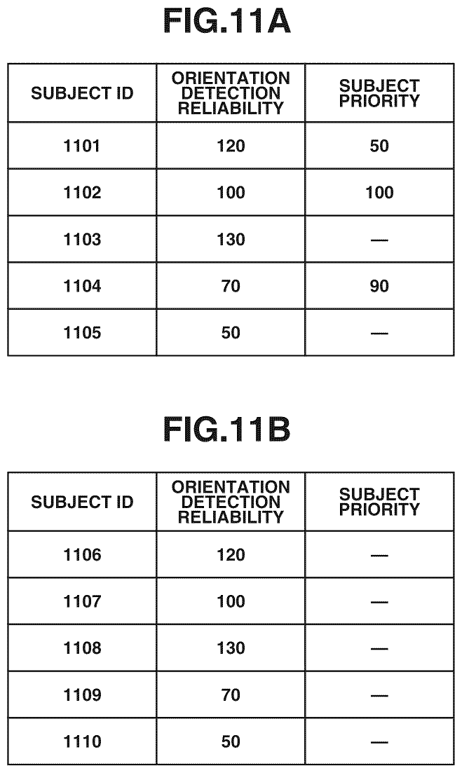

If there is no registered subject in the detected subjects (i.e., if the specific subject is authenticated from none of subjects), a subject is determined to be the main subject in the order of subjects having a high orientation detection reliability, and detected subjects without the orientation information and the authentication information. FIGS. 11A and 11B illustrate examples of the subject information when the main subject determination unit 212 determines the main subject. If there is a plurality of pieces of subject information as illustrated in FIG. 11A, the main subject determination unit 212 determines a subject 1102 having the highest subject priority as the main subject. Referring to FIG. 11B, since there is no registered subject in the detected subjects, the main subject determination unit 212 determines a subject 1108 having the highest orientation detection reliability as the main subject. For example, when preferentially capturing a specific person in a game of sports, the above-described main subject determination processing enables keeping selecting the person as the main subject while the relevant person is within the angle of view. If the person is out of the angle of view, a person in a shooting orientation can be preferentially determined as the main subject.

As described above, according to the fifth embodiment, the main subject is determined based on the subject priority if there is a plurality of main subject candidates. Among the detected subjects, the subject having the highest subject priority is determined as the main subject. If there is no registered subject in the detected subjects, the main subject can be selected in the order of subjects having a high orientation detection reliability, and detected subjects without the orientation information and the authentication information. This enables selecting the main subject in consideration of the orientation detection information while giving priority to the detected subjects.

A sixth embodiment has a similar basic configuration of the imaging apparatus 100 to the first to the fifth embodiments. Differences of the present embodiment from the first embodiment will be mainly described below. The present embodiment can be incorporated as interrupt processing in the first to the fifth embodiments. More specifically, in each embodiment, the priority setting made by the user may be given higher priority than the priority setting in the embodiment.

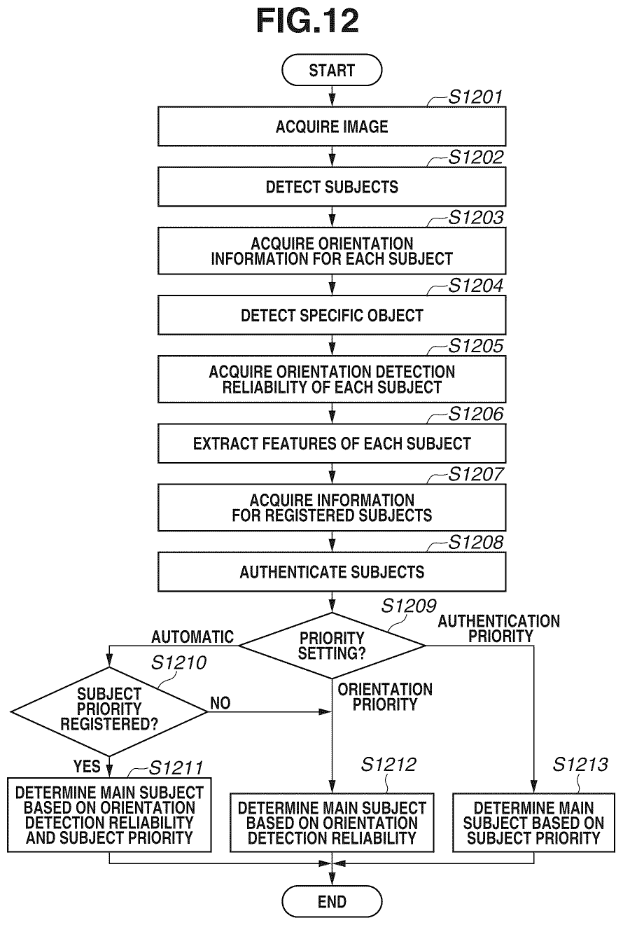

FIG. 12 is a flowchart illustrating the main subject determination processing according to the present embodiment. In step S1209, a priority setting acquisition unit 213 acquires the priority setting made by the user. The priority setting is used to specify which of the subject with the specific orientation detected and a registered subject is to be more preferentially determined as the main subject. For example, a selection screen displayed on the display unit 150 allows the user to select the priority setting from Automatic, Orientation Priority, and Authentication Priority. When Automatic is selected, the processing proceeds to step S1210. When Orientation Priority is selected, the processing proceeds to step S1212. When Authentication Priority is selected, the processing proceeds to step S1213.

In step S1210, the main subject determination unit 212 checks whether the subject priority is registered.

If the subject priority is registered (YES in step S1210), the processing proceeds to step S1211. If the subject priority is not registered (NO in step S1210), the processing proceeds to step S1212.

In step S1211, the main subject determination unit 212 performs the main subject determination processing based on the orientation detection reliability included in the orientation information acquired in step S1205 and the subject priority acquired in step S1208.

The processing in step S1211 is similar to the processing in step S311 according to the first embodiment.

In step S1212, the main subject determination unit 212 performs the main subject determination processing, giving priority to the orientation detection reliability included in the orientation information acquired in step S1205. The processing in step S1212 is similar to the processing in step S609 according to the third embodiment.

In step S1213, the main subject determination unit 212 determines the main subject, giving priority to the subject priority included in the authentication information acquired in step S1208. The processing in step S1212 is similar to the processing in step S1009 according to the fifth embodiment.

As described above, the sixth embodiment allows the user to specify which of the subject with the specific orientation detected and a registered subject is to be more preferentially determined as the main subject. This enables the main subject determination intended by the user to be performed in consideration of the orientation detection information and the registered subject information.

### OTHER EMBODIMENTS

The object of the present invention can also be achieved by the following method. More specifically, a storage medium storing a program code of software describing procedures for implementing the functions of the above-described embodiments is supplied to a system or apparatus. Then, a computer (or CPU or MPU) of the system or apparatus reads the program code stored in the storage medium and then executes the program code.

In this case, the program code itself read from the storage medium implements new functions of the present invention, and the storage medium storing the program code and the program also constitute the present invention.

Examples of storage media for supplying the program code include a flexible disk, hard disk, optical disk, and magneto-optical (MO) disk. In addition, a compact disc read only memory (CD-ROM), compact disc recordable (CD-R), compact disk rewritable (CD-RW), digital versatile disc read only memory (DVD-ROM), digital versatile disc random access memory (DVD-RAM), digital versatile disc rewritable (DVD-RW), digital versatile disc recordable (DVD-R), magnetic tape, nonvolatile memory card, and ROM are also applicable.

The functions of the above-described embodiments are implemented when the computer executes the read program code. Further, a case where an operating system (OS) operating on the computer performs part or whole of actual processing based on instructions of the program code, and the functions of the above-described embodiments are implemented by the processing is also included in the present invention.

The following cases are also included in the present invention. First, the program code read from the storage medium is stored in a memory included in a function expansion board inserted into the computer or a function expansion unit connected to the computer. Then, a CPU included in the function expansion board or function expansion unit executes part or whole of actual processing based on instructions of the program code.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention makes it possible to determine the main subject close to the one intended by a photographer even from among a plurality of subjects, based on orientation information and registered person information.

While the present disclosure has been described with reference to embodiments, it is to be understood that the present disclosure is not limited to the disclosed embodiments, but is defined by the scope of the following claims.

This application claims the benefit of Japanese Patent Application No. 2024-103359, filed Jun. 26, 2024, which is hereby incorporated by reference herein in its entirety.

What is claimed is:

1. An image processing apparatus comprising:
one or more processors; and
at least one memory coupled to the one or more processors and having stored thereon instructions, which when executed by the one or more processors, cause the image processing apparatus to function as:
a detection unit configured to detect a subject and a specific orientation of the subject from an image;
an authentication unit configured to, based on information about a pre-registered specific subject, authenticate the specific subject; and
a determination unit configured to, in a plurality of subjects detected from the image, determine a main subject based on a result of the specific orientation detection by the detection unit and a result of the authentication by the authentication unit.

2. The image processing apparatus according to claim 1, wherein, in a case where the specific orientation is detected on a first subject by the detection unit, the determination unit is configured to determine the first subject as the main subject even if there exists a subject authenticated as the specific subject by the authentication unit from among subjects other than the first subject.

3. The image processing apparatus according to claim 1,
wherein the detection unit is configured to calculate a score of a likelihood of the specific orientation,
wherein the authentication unit is configured to determine a priority of the specific subject authenticated based on a subject priority set for each specific subject, and
wherein the determination unit is configured to determine the main subject based on the score and the priority.

4. The image processing apparatus according to claim 3, wherein the determination unit is configured to determine the main subject based on an orientation type included in orientation information of the subject.

5. The image processing apparatus according to claim 1, wherein the detection unit is configured to detect joints of a subject and positions of the joints in the image, and detects a scoring-related orientation and a scoring-unrelated orientation based on the joint positions and a ball position.

6. The image processing apparatus according to claim 5, wherein the scoring-related orientation includes at least one of a shooting orientation and a spike orientation, and the scoring-unrelated orientation includes at least one of a pass orientation, a receive orientation, and a toss orientation.

7. The image processing apparatus according to claim 1, wherein, in a case where a second subject is authenticated as the specific subject, the determination unit is configured to determine the second subject as the main subject even if there exists a subject other than the second subject with the specific orientation detected.

8. The image processing apparatus according to claim 1,
wherein the detection unit is configured to calculate a score of a likelihood of the specific orientation,
wherein the authentication unit is configured to calculate an authentication reliability indicating a likelihood of the specific subject, and
wherein the determination unit is configured to determine the main subject based on the score and the authentication reliability.

9. The image processing apparatus according to claim 1, further comprising a setting unit configured to set which of the result of the specific orientation detection by the detection unit and the result of the authentication by the authentication unit is to be preferentially used to determine the main subject, wherein the determination unit is configured to determine the main subject based on the setting by the setting unit.

10. The image processing apparatus according to claim 1,
wherein the determination unit is configured to determine the main subject with respect to an image captured by an imaging unit, and
wherein the image processing apparatus further comprises a control unit configured to control the imaging unit based on information about the main subject determined by the determination unit.

11. The image processing apparatus according to claim 1, wherein the detection unit is configured to detect joints of a subject and positions of the joints in the image, and calculate a score of a likelihood of the specific orientation based on the positions of the joints to detect the specific orientation.

12. The image processing apparatus according to claim 11, wherein the detection unit is configured to detect the joints of a subject and positions of the joints by using a first learning model trained by machine learning, and calculate the score of the likelihood of the specific orientation by using a second learning model trained by machine learning.

13. An image processing apparatus comprising:
one or more processors; and
at least one memory coupled to the one or more processors and having stored thereon instructions, which when executed by the one or more processors, cause the image processing apparatus to function as:
a detection unit configured to detect a subject and a specific orientation of the subject from an image;
an authentication unit configured to, based on information about a pre-registered specific subject, authenticate the specific subject; and
a determination unit configured to, in a plurality of subjects detected from the image, determine the main subject based on a result of the specific orientation detection by the detection unit and a result of the authentication by the authentication unit,
wherein the determination unit is configured to preferentially determine the subject with the specific orientation detected, as the main subject, instead of a subject with the specific orientation undetected and having been authenticated as the specific subject.

14. The image processing apparatus according to claim 13,
wherein the detection unit is configured to calculate a likelihood of the specific orientation, and
wherein the determination unit is configured to determine the subject having a highest likelihood of the specific orientation as the main subject.

15. A method for controlling an image processing apparatus, the method comprising:
detecting a subject and a specific orientation of the subject from an image;
authenticating, based on information about a pre-registered specific subject, the specific subject; and
determining, in a plurality of subjects detected from the image, the main subject based on a result of the specific orientation detection by the detection unit and a result of the authentication by the authentication unit.

16. A method for controlling an image processing apparatus, the method comprising:
detecting a subject and a specific orientation of the subject from an image;
authenticating, based on information about a pre-registered specific subject, the specific subject; and
determining, in a plurality of subjects detected from the image, a main subject based on a result of the specific orientation detection by the detection and a result of the authentication by the authentication,
wherein, in the determination, the subject with the specific orientation detected is preferentially determined as the main subject than a subject with the specific orientation undetected and having been authenticated as the specific subject.

17. A non-transitory computer-readable storage medium storing a program comprising instructions which, when the program is executed by a computer, cause the computer to carry out the method of claim 15.
